(19) United States
(12) Patent Application Publication
(10) Pub. No.: US 2007/0183547 A1
(43) Pub. Date: Aug. 9, 2007

(54) Method of, and receiver for, cancelling interferring signals

(75) Inventors: Robert Fifield, Redhill (GB); Paul Bucknell, Brighton (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/588,581

(22) PCT Filed: Feb. 1, 2005
(86) PCT No.: PCT/IB05/50424

§ 371 Date: Aug. 4, 2006

(30) Foreign Application Priority Data
Feb. 4, 2004 (GB) 0402407.1

(51) Int. Cl. H04B 1/10; H04L 7/00

(52) U.S. Cl. 375/349; 375/355

(57) ABSTRACT

A method of, and receiver for, cancelling an unwanted first signal having a bandwidth at least a part of which overlies the bandwidth of a wanted second signal, the bandwidth of one of the first and second signals being greater than that of the other The method comprises receiving the first and second signals (10, 12) and respectively frequency down converting (18,22,26 and 20,24,28) the first and second signals to provide first and second low frequency signals. The first and second low frequency signals are digitised using synchronised ADCs (30,32) to provide respective first and second digitised signals, the wider bandwidth signal being digitised at a higher sampling rate and the lower bandwidth signal being digitised at a lower sampling rate. The sampling rate of one of the first and second digitised signals is adjusted (44) to be the same as the other of the first and second digitised signals. Thereafter the frequency of the unwanted signal is shifted (46) to be in the same relative position with respect to the wanted signal as it appeared in the received signal. An output signal is derived by obtaining the difference (40) between the wanted and unwanted signals. In a refinement of the basic method the unwanted signal from the respective ADC is cleaned-up by demodulating it (52) and modulating it (54) which gives the benefit that when subtracting one signal from the other, the section of the wanted signal under the interferer is left intact.

The present invention relates to a method of, and receiver for, cancelling interfering signals. The present invention has particular, but not exclusive, application to cancelling a received narrowband interfering signal, such as a Bluetooth, Registered Trade Mark (®) signal, present in a received wideband signal, such as a IEEE 802.11g and vice versa. The present invention can be applied to multi-mode operation and can be multiple input multiple output (MIMO) enabled.

The prior art discloses numerous methods of cancelling unwanted interfering signals present in the bandwidth of a wanted signal. As an example EP-A1 1 176 731 discloses a method of interference cancellation of a narrowband interferer, such as Bluetooth®, in a wide band communication device for receiving signals transmitted in accordance with IEEE 802.11, IEEE 802.11 or IEEE 802.15.3. The architecture of the device comprises a Bluetooth® receiver and a wideband receiver having inputs coupled to a common antenna and outputs coupled to a controller. In one embodiment the wideband receiver has the ability to implement within it a plurality of digital or analogue notch filters tuned to the hopping frequencies used in the received, locally used Bluetooth® piconets. In operation, a particular notch filter is implemented in response to the Bluetooth® receiver determining the presence of a particular narrowband signal, and a notch corresponding to that narrowband signal is introduced into the output of the wideband receiver which blocks not only the unwanted narrowband signal but also the relevant portion of the band of the wanted signal.

In an alternative embodiment, EP-A1 1 176 731 discloses the respective receivers jointly detecting their respective data packets, the Bluetooth® receiver decoding its data packet which is then subtracted from the whole signal received by the wideband receiver using conventional filtering or other techniques.

A drawback to the cited interference cancelling technique is that it requires the provision of two independent radio receivers in order to be able to receive one wanted wideband signal and one unwanted narrowband signal. The use of two independent receivers is not only relatively costly but also requires a relatively large amount of power which is a disadvantage in battery powered devices. Additionally the citation teaches the use of a notch filter which is not particularly efficient and also is against current receiver architecture philosophy which is against using mixed analogue and/or digital filtering.

It is an object of the present invention to effect signal interference cancellation in an efficient cost effective manner.

According to one aspect of the present invention there is provided a method of cancelling an unwanted first signal having a bandwidth at least a part of which overlies the bandwidth of a wanted second signal, the bandwidth of one of the first and second signals being greater than that of the other, the method comprising receiving the first and second signals, respectively frequency down converting the first and second signals to provide first and second low frequency signals, respectively digitising the first and second low frequency signals using synchronised ADCs to provide respective first and second digitised signals, the wider bandwidth signal being digitised at a higher sampling rate and the lower bandwidth signal being digitised at a lower sampling rate, frequency shifting the frequency down converted unwanted signal to a preselected position in the frequency down converted wanted signal, adjusting sampling rate of the first digitised signal to be the same as the second digitised signal and forming the difference between the second and first digitised signals to provide an output signal.

According to a second aspect of the present invention there is provided a radio receiver comprising a receiving stage having a bandwidth to receive a wanted signal and an unwanted signal, a first frequency down conversion means for converting the wanted signal to a first low IF signal, first ADC means operating at a first sampling rate for digitising the first low IF signal, a second frequency down conversion means for converting the unwanted signal to a second low IF signal having a centre frequency which may be different from that of the first low IF signal, second ADC means operating at a second sampling rate for digitising the second low IF signal, the first and second sampling rates being different with the lower rate being a sub-multiple of, and being synchronised with, the higher rate, frequency shifting means for shifting the frequency down converted unwanted signal to a preselected position in the frequency down converted wanted signal, sampling rate adjusting means for adjusting the sample rate of the unwanted signal to be the same as the sampling rate of the wanted signal, and differencing means for obtaining the difference between the digitised signals having the same sampling rates.

A multi-mode radio receiver is likely to have multiple ADCs and it is likely that these can be used for interference cancellation with little or no overhead on the overall component count.

The method and receiver architecture in accordance with the present invention makes use of two ADCs, one for the wideband signal and the other for the narrowband signal, which avoids the need for two independent receivers. The use of two ADCs to cancel interference avoids having to use extra analogue components. The interference cancellation problem is transferred into the digital domain which has the advantages of being more flexible, not being prone to tolerance issues, and becoming more power efficient as CMOS processes shrink. Further by running one of the two ADCs at a much lower rate, say a factor of ten lower, the impact on power consumption is minimised.

Compared to the prior art there is no requirement for high speed variable notch filters which not only leads to a simplification of the architecture but also saves current.

The method and receiver architecture in accordance with the present invention can also be used not only to remove narrowband interference from a wideband signal but also to remove wideband interference from a narrowband signal, the requirement being that the wanted and unwanted signals have differently sized frequency bands. However the frequency band of the interfering signal should be known or be able to be determined in advance.

In a first embodiment of the present invention a frequency notch corresponding to the bandwidth of the unwanted narrowband signal is removed from the wanted wideband signal.

In another embodiment of the present invention the received interferer is demodulated and then reconstructed in order to clean-up the interferer. The reconstructed signal is then subtracted from the wanted wideband signal in an attempt to remove only the interferer and leave the portion of the wideband signal under the interferer intact.

If desired automatic gain control may be applied to equalize the signal amplitudes applied to the subtracting stage. Thus a relatively strong interfering signal can be prevented from overwhelming a relatively weak wanted signal.

The present invention will now be described, by way of example, with reference to the accompanying drawings, wherein:

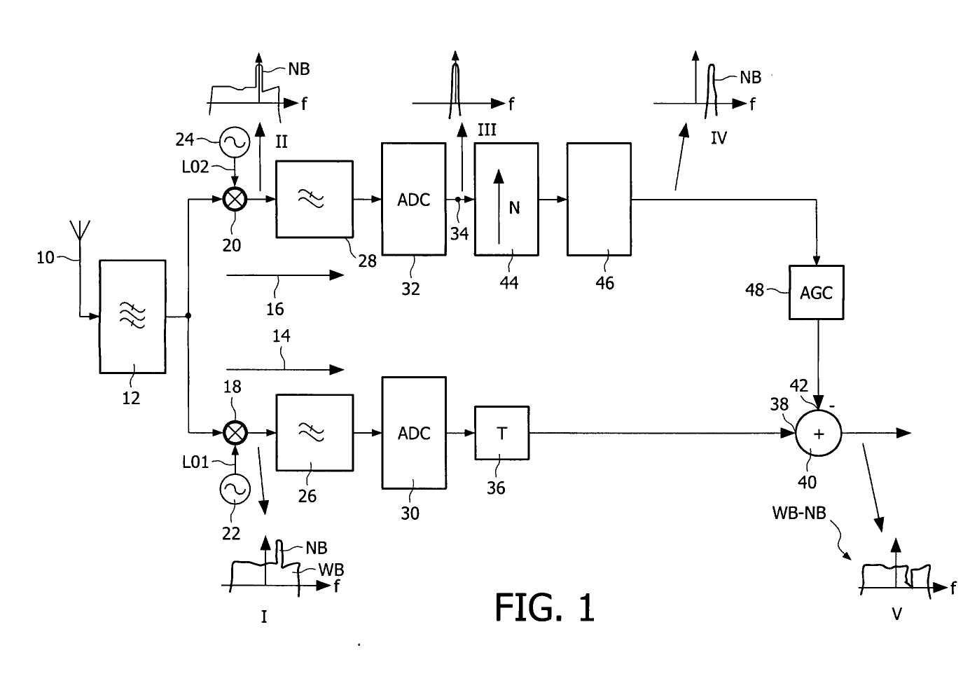

FIG. 1 is a block schematic diagram of a first embodiment of a receiver made in accordance with the present invention,

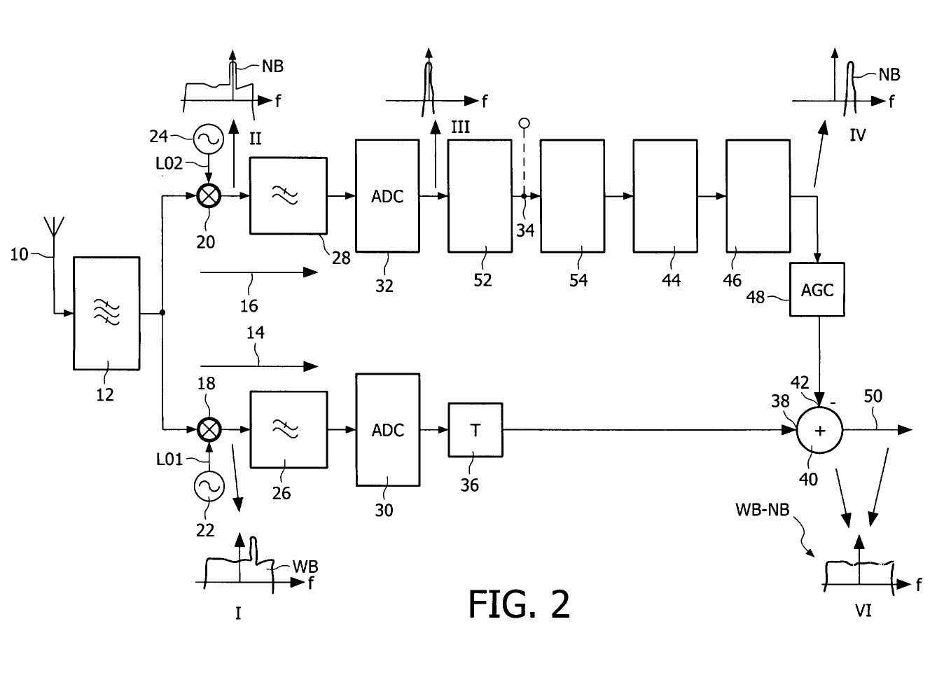

FIG. 2 is a block schematic diagram of a second embodiment of a receiver made in accordance with the present invention, and

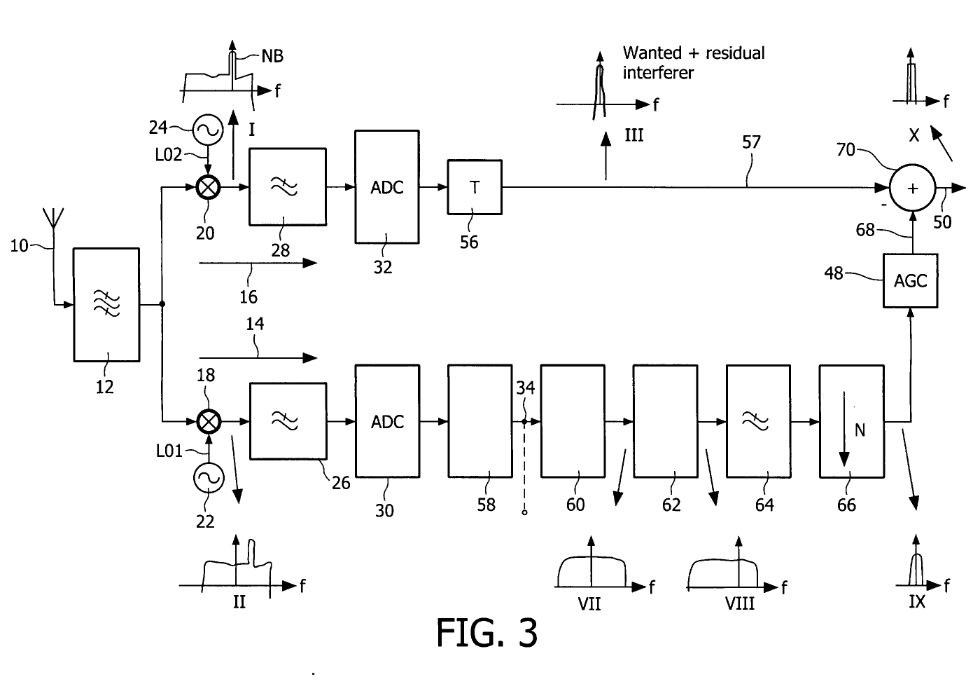

FIG. 3 is a block schematic diagram of a third embodiment of a receiver made in accordance with the present invention.

In the drawings the same reference numerals have been used corresponding features.

For convenience of description the embodiments of the invention will be described with reference to the use of narrowband Bluetooth®signals and wideband IEEE 802.11g signals. As is known both signals use the ISM (Industrial, Scientific and Medical) band and the Bluetooth® signals are frequency hopped signals whereas the IEEE 802.11g signals are spread spectrum signals. However it is to be understood that the present invention is not restricted to any particular modulation scheme, or frequency bands.

Referring the receiver shown in FIG. 1, an antenna 10 is coupled to a RF bandpass filter 12 which may include a low noise amplifier (not shown).

The passband of the filter 12 is selected to pass a wideband signal WB together with a narrowband interferer signal NB lying within the frequency band of the wideband signal. The frequency bandwidths of both signals are known or can be determined in advance if one of them varies in a predictable manner, for example as a result of frequency hopping. The output of the filter 12 is split and supplied to first and second signal paths 14, 16. These signal paths are in reality complex signal paths but for the sake of simplicity have been shown as single channel paths. The first signal path 14 is implemented to recover the wideband signal WB, which signal in this embodiment is the wanted signal, and the second signal path 16 is implemented to recover the narrowband signal NB, which signal is the interferer and is removed from the wideband signal.

The first signal path 14 comprises a first mixer 18 having a first input for the signals derived from the output of the filter 12. A first local oscillator 22 is coupled to a second input of the mixer 18. The frequency LO1 of the first local oscillator 22 is selected to mix the centre frequency of the wideband signal WB to a low or zero IF. It will be noted from the inset spectrum diagram I that the narrowband signal NB is offset from zero. A low pass filter 26 is coupled to an output of the first mixer 18, the bandwidth of the filter is such as to pass the wideband signal. An output from the filter 26 is digitised in a first analog-to-digital converter (ADC) 30 having a relatively high sampling frequency, for example 20 MHz in the case of the wideband signal being in accordance with IEEE 802.11. The digitised signal is applied to a delay stage 36. This stage 36 introduces a time delay τ to compensate for processing delays in the second signal path 16. An output of the delay stage 36 is coupled to a first input of a subtraction stage 40.

The second signal path 16 comprises a second mixer 20 having a first input for the signals derived from the output of the filter 12. A second local oscillator 24 is coupled to a second input of the mixer 20. The frequency LO2 of the second local oscillator 24 is selected to mix the centre frequency of the narrowband signal NB to a low or zero IF. It will be noted from the inset spectrum diagram II that the narrowband signal NB is centred on zero frequency. A low pass filter 28 is coupled to an output of the second mixer 20, the bandwidth of the filter is such as to pass the narrowband signal. An output from the filter 28 is digitised in a second ADC 32 having a relatively low sampling frequency, for example 2 MHz in the case of the narrowband signal being in accordance with Bluetooth®. The sampling clocks of the ADCs 30, 32 are synchronised, that is, phase locked. If desired the narrowband signal, as shown in diagram III, may be derived from a junction 34 in the output signal path from the ADC 32. This output is applied to a stage 44 in which the sampling frequency is increased by a factor N to be the same as that of the digitised wideband signal. In the case of the respective signals being in accordance with IEEE 802.11 and Bluetooth®specifications, N=10. An output of the stage 44 is coupled to a frequency shifting stage 46 which shifts the centre frequency of the narrowband signal NB to align it with the narrowband signal present in the output of the ADC 30. This is shown in the inset diagram IV. An automatic gain control (AGC) stage 48 is coupled between an output of the frequency shifting stage 46 and a second, inverting input of the subtraction stage 40. The purpose of the AGC stage 48 is to equalize the relative amplitudes of the signals at the inputs 38 and 42 of the subtraction stage 40. The signal on an output 50 of the subtraction stage 40 is the digitised wideband signal with a notch in the frequency spectrum corresponding to the subtracted interferer, see inset diagram V.

Superhet frequency down conversion stages may be used instead of the complex stages described. The use of ADCs 30, 32 is more efficient than having very sharp notch filters because they use components already existing in a narrow band and a wideband receiver. The sampling frequency of the ADC 32 is selected having regard to choosing the lowest possible sampling frequency in order to minimise power consumption whilst ensuring obtaining the desired fidelity. Depending on the precise architecture of the receiver, the AGC stage may be connected in the first signal path 14 or a pair of AGC stages may be provided, each one being in a respective one of the first and second signals paths 14, 16.

Referring to the embodiment of the receiver shown in FIG. 2, the illustrated architecture is intended to avoid loss of the wanted signal in the portion of the spectrum occupied by the interfering narrowband signal NB. In the interests of brevity the first signal path 14 will not be described as it is identical to the shown in FIG. 1. The signal path 16 is modified compared to that shown in FIG. 1 by demodulating the output of the ADC 32 using a demodulator 52 and subsequently reconstructing the narrowband signal NB, without extraneous interference, such as noise, by modulating it in a modulator 54. The demodulator 52 and the modulator 54 may comprise sigma-delta devices. Thereafter the sampling frequency of the digitised signal is increased by N in the stage 44 and frequency shifted in the frequency shifting stage 46. The gain of the narrowband signal is adjusted in the AGC stage 48 and the output from this stage is coupled to the input 42 of the subtraction stage 40. The signal on the output 50 from the subtraction stage 40 is shown in the inset diagram VI and unlike the receiver shown in FIG. 1 there is no conspicuous notch because in FIG. 2 it is intended that only the interferer be removed leaving the section of the wideband signal under the interferer intact.

FIG. 3 illustrates an embodiment of a receiver for doing the converse of what is done by that shown in FIG. 2, namely, cancelling the wideband signal WB which is regarded as the interferer and preserving the narrowband signal NB as the wanted signal. Compared to FIG. 2 the architectures of the first and second signal paths 14 and 16 have in effect been reversed but for the sake of consistency in describing FIG. 3 the first path 14 processes the wideband signal and the second signal path 16 processes the narrowband signal.

An antenna 10 is coupled to a RF bandpass filter 12 which may include a low noise amplifier (not shown). The passband of the filter 12 is selected to pass a wideband interferer signal WB together with a narrowband wanted signal NB lying within the frequency band of the wideband signal. The frequency bandwidths of both signals are known or can be determined in advance. The output of the filter 12 is split and supplied to first and second signal paths 14, 16. These signal paths are in reality complex signal paths but for the sake of simplicity have been shown as single channel paths. The first signal path 14 is implemented to recover the wideband signal WB, which signal in this embodiment is the interferer, and the second signal path 16 is implemented to recover the narrowband signal NB, which is the wanted signal and needs to be preserved.

For convenience the second signal path 16 will be described first. The second signal path 16 comprises a second mixer 20 having a first input for the signals derived from the output of the filter 12. A second local oscillator 24 is coupled to a second input of the mixer 20. The frequency LO2 of the second local oscillator 24 is selected to mix the centre frequency of the narrowband signal NB to a low or zero IF. It will be noted from the inset waveform diagram I that the narrowband signal NB is at a zero IF. A low pass filter 28 is coupled to an output of the second mixer 20, the bandwidth of the filter is such as to pass the narrowband signal. An output from the filter 28 is digitised in a second ADC 32 having a relatively low sampling frequency, for example 2 MHz in the case of the narrowband signal being in accordance with Bluetooth®. The digitised signal is applied to a delay stage 56. This stage 56 introduces a time delay T to compensate for processing delays in the first signal path 14. The wanted signal and the residual interferer, see inset diagram III, appear at the output of the delay stage 56, the output is coupled to a first input 57 of a subtraction stage 70.

The first signal path 14 comprises a first mixer 18 having a first input for the signals derived from the output of the filter 12. A first local oscillator 22 is coupled to a second input of the mixer 18. The frequency LO1 of the first local oscillator 22 is selected to mix the centre frequency of the wideband signal WB to a low or zero IF, as shown in the inset spectrum diagram II. A low pass filter 26 is coupled to an output of the first mixer 18, the bandwidth of the filter is such as to pass the wideband signal. An output from the filter 26 is digitised in a first ADC 30 having a relatively high sampling frequency, for example 20 MHz in the case of the wideband signal being in accordance with IEEE 802.11.

The sampling clocks of the ADCs 30, 32 are synchronised, that is, phase locked. The output of the ADC 30 is coupled to a demodulator 58, the output from which is reconstructed by modulating it in a modulator 60. As shown in the inset diagram VII the reconstructed wideband signal has been stripped of extraneous interference, such as noise. Thereafter the reconstructed signal is applied to a frequency shifting stage 62 which shifts the centre frequency of the wideband signal to align it with the narrowband signal, as shown in the inset diagram VIII. The output from the frequency shifting stage is applied to a low pass filter 64 which has bandwidth comparable to that of the low pass filter 28. The output from the filter 64 has its sampling frequency decreased by a factor N in a stage 66, where in this example N= 1/10, so that it equals that of the narrowband signal. Diagram IX illustrates the output of the stage 66. The gain of the wideband signal is adjusted in the AGC stage 48 and the output from this stage is coupled to the input 68 of the subtraction stage 70. The signal on the output 50 from the subtraction stage 70 is shown in the inset diagram X and comprises the wanted signal with most of the interferer removed.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of interference reducing receivers and component parts therefor and which may be used instead of or in addition to features already described herein.

1. A method of cancelling an unwanted first signal having a bandwidth at least a part of which overlies the bandwidth of a wanted second signal, the bandwidth of one of the first and second signals being greater than that of the other, the method comprising receiving the first and second signals, respectively frequency down converting the first and second signals to provide first and second low frequency signals, respectively digitising the first and second low frequency signals using synchronised ADCs to provide respective first and second digitised signals, the wider bandwidth signal being digitised at a higher sampling rate and the lower bandwidth signal being digitised at a lower sampling rate, frequency shifting the frequency down converted unwanted signal to a preselected position in the frequency down converted wanted signal, adjusting sampling rate of the first digitised signal to be the same as the second digitised signal and forming the difference between the second and first digitised signals to provide an output signal.

2. A method as claimed in claim 1, characterised in that local oscillator frequencies used for frequency down converting the first and second signals are selected to correspond to substantially the centre of their respective frequency bands and in that the centre frequency of unwanted signal is shifted to correspond to the centre frequency of the wanted signal.

3. A radio receiver comprising a receiving stage having a bandwidth to receive a wanted signal and an unwanted signal, a first frequency down conversion means for converting the wanted signal to a first low IF signal, first ADC means operating at a first sampling rate for digitising the first low IF signal, a second frequency down conversion means for converting the unwanted signal to a second low IF signal having a centre frequency which may be different from that of the first low IF signal, second ADC means operating at a second sampling rate for digitising the second low IF signal, the first and second sampling rates being different with the lower rate being a sub-multiple of, and being synchronised with, the higher rate, frequency shifting means for shifting the frequency down converted unwanted signal to a preselected position in the frequency down converted wanted signal, sampling rate adjusting means for adjusting the sample rate of the unwanted signal to be the same as the sampling rate of the wanted signal, and differencing means for obtaining the difference between the digitised signals having the same sampling rates.

4. A receiver as claimed in claim 3, characterised by demodulation means coupled to an output of the second ADC means for recovering the unwanted signal, and modulation means for modulating the recovered unwanted signal, the output of the modulation means being coupled to the sampling rate adjusting means.

5. A receiver as claimed in claim 4, characterised by the frequency shifting means being adapted to shift the centre frequency of the unwanted digitised signal to substantially the centre frequency of the wanted digitised signal.

6. A receiver as claimed in claim 3, characterised by automatic gain control means for controlling the amplitude of at least one of the inputs to the differencing means.

7. A receiver as claimed in claim 3, characterised in that the first frequency down conversion means is provided for frequency down converting a wanted narrowband signal, in that the second frequency down conversion means is provided for frequency down converting an unwanted wideband signal, and in that the sampling rate of the second ADC means is greater than the sampling rate of the first ADC means.

8. A receiver as claimed in claim 7, characterised in that the first and second frequency down conversion means provide complex outputs.

9. A receiver as claimed in claim 7, characterised by means for equalizing the relative amplitudes of the signals applied to the means for obtaining the difference.

10. A receiver as claimed in claim 7, characterised by a demodulator coupled the one of the first and second ADC means generating an interfering signal for recovering the said signal and a modulator coupled to an output of the demodulator.
